(19) United States
(12) Patent Application Publication
(10) Pub. No.: US 2018/0107064 A1
(43) Pub. Date: Apr. 19, 2018

(54) BACKLIGHT MODULE AND LIQUID CRYSTAL DISPLAY DEVICE

(71) Applicant: Shenzhen China Star Optoelectronics Technology Co., Ltd., Shenzhen, Guangdong (CN)

(72) Inventor: Bai BAI, Shenzhen, Guangdong (CN)

(73) Assignee: Shenzhen China Star Optoelectronics Technology Co., Ltd., Shenzhen, Guangdong (CN)

(21) Appl. No.: 15/112,143

(22) PCT Filed: May 10, 2016
(86) PCT No.: PCT/CN2016/081506

§ 371 Date: Jul. 15, 2016

(30) Foreign Application Priority Data
Apr. 5, 2016 (CN) 201610207711.5

(51) Int. Cl. G02F 1/1335; F21V 8/00

(52) U.S. Cl. CPC G02F 1/133603; G02B 6/0025; G02F 2001/133548; G02B 6/0056; G02F 1/133528

(57) ABSTRACT

The present application discloses a backlight module and a liquid crystal display device, the application utilizes a metal wire grid polarizing film instead of the rear polarizer, and an additional layer of quarter-wave plate is deposited on the reflective sheet. The light emitted from the light source and passed into the metal wire grid polarizing film, the light component perpendicular to the metal wire grid is effectively utilized, the light components parallel to the metal wire grid is reflected into the quarter-wave plate, the reflected light is converted into circularly polarized light by the quarter wave plate, after reflected by the reflective sheet, the direction of the circularly polarized light is reversed, the reversed circularly polarized light is further pass the quarter wave plate and into a polarized light perpendicular to the metal wire grid

### FIELD OF THE INVENTION

The present application relates to a Liquid crystal display, LCD field, and more particularly to a backlight module and a Liquid crystal display with the backlight module.

### BACKGROUND OF THE INVENTION

The liquid crystal display device includes a display panel and a backlight module, wherein the backlight module is a component to provide light source to the liquid crystal display device, and typically disposed below the liquid crystal panel, to provide uniform brightness and a certain diverging light to the liquid crystal panel, and forming the color display according to the different voltage of the pixel electrode of the liquid crystal display device into different brightness, different colors or different grayscale. According to the positional relationship between the light source and the light guide plate, the backlight module can be divided into two parts: the direct type backlight module and the edge type backlight module, and the edge type backlight module is widely used because of its advantages such as its thin thickness.

In the edge type backlight module, the light emits from the light source and into the edge of the light guide plate, the light guide plate converts the light into uniform surface light and then the light emits and through the rear polarizer, the light becomes linearly polarized light, and reaches the liquid crystal panel. However, only the linearly polarized light can pass the rear polarizer in the conventional backlight module, that is, partial of the light emitted from the light guide plate cannot pass the rear polarizer, and the light cannot pass the rear polarizer were wasted, resulting in the lower light utilization rate.

### SUMMARY OF THE INVENTION

The purpose of the present application is to provide a backlight module and a liquid crystal display to solve the problem of the lost of light during light transmission and the problem of the low light utilization rate.

A backlight module is provide in the present application including a light guide plate having a light incident surface, a light emitting surface and a reflective surface respectively connected to the light incident surface and opposite to each other; a light source provided adjacent to the light incident surface, and the light source having a blue LED, red quantum dots and green quantum dots, the light emitted from the blue LED is mixed with the red quantum dots and green quantum dots to form white light; a diffusion sheet provided adjacent to the light emitting surface of the light guide plate; a metal wire grid polarizing film disposed on a side of the light emitting surface of the light guide plate, and the diffusion sheet is disposed between the light guide plate and the metal wire grid polarizing film; a quarter-wave plate disposed adjacent to the reflective surface of the light guide plate, wherein the angle between the fast axis of the quarter wave plate and the direction of the metal wire grid of the metal wire grid polarizing film is 45°; and a reflective sheet disposed on the side of the quarter-wave plate facing away from the light guide plate.

Wherein the red quantum dots and the green quantum dots are dispersed in a first quantum dot film and a second quantum film, wherein the first quantum dot film and a second quantum film are disposed between the blue LED and the light incident surface of the light guide plate, or disposed one the light emitting surface of the light guide plate.

Wherein the red quantum dots and the green quantum dots are dispersed in one quantum dot film, wherein the quantum dot film is disposed between the blue LED and the light incident surface of the light guide plate, or disposed one the light emitting surface of the light guide plate.

A backlight module is provide in the present application including a light guide plate having a light incident surface, a light emitting surface and a reflective surface respectively connected to the light incident surface and opposite to each other; a light source provided adjacent to the light incident surface; a metal wire grid polarizing film disposed on a side of the light emitting surface of the light guide plate; a quarter-wave plate disposed adjacent to the reflective surface of the light guide plate, wherein the angle between the fast axis of the quarter wave plate and the direction of the metal wire grid of the metal wire grid polarizing film is 45°; and a reflective sheet disposed on the side of the quarter-wave plate facing away from the light guide plate.

Wherein the light source further including a blue LED, red quantum dots and green quantum dots, the light emitted from the blue LED is mixed with the red quantum dots and green quantum dots to form white light.

Wherein the red quantum dots and the green quantum dots are dispersed in a first quantum dot film and a second quantum film, wherein the first quantum dot film and a second quantum film are disposed between the blue LED and the light incident surface of the light guide plate, or disposed one the light emitting surface of the light guide plate.

Wherein the red quantum dots and the green quantum dots are dispersed in one quantum dot film, wherein the quantum dot film is disposed between the blue LED and the light incident surface of the light guide plate, or disposed one the light emitting surface of the light guide plate.

Wherein the backlight module further including a diffusion sheet provided adjacent to the light emitting surface of the light guide plate.

A liquid crystal display device is provide in the present application including a liquid crystal panel and a backlight module to provide light to the liquid crystal panel, wherein the backlight module further including: a light guide plate having a light incident surface, a light emitting surface and a reflective surface respectively connected to the light incident surface and opposite to each other; a light source provided adjacent to the light incident surface; a metal wire grid polarizing film disposed on a side of the light emitting surface of the light guide plate; a quarter-wave plate disposed adjacent to the reflective surface of the light guide plate, wherein the angle between the fast axis of the quarter wave plate and the direction of the metal wire grid of the metal wire grid polarizing film is 45°; and a reflective sheet disposed on the side of the quarter-wave plate facing away from the light guide plate.

Wherein the liquid crystal panel including a first substrate and a second substrate; and a liquid crystal layer filled between the first substrate and the second substrate; wherein the metal wire grid polarizing film is disposed between the first substrate and the second substrate and is disposed adjacent to the liquid crystal layer toward to the side of the light guide plate.

Wherein the liquid crystal panel including a first substrate and a second substrate; and a liquid crystal layer filled between the first substrate and the second substrate; wherein the second substrate is disposed adjacent the light emitting surface of the light guide plate, and the metal wire grid polarizing film is disposed between the first substrate and the light emitting surface of the light guide plate.

Wherein the liquid crystal display device including a front polarizer disposed on the side of the first substrate opposite to the liquid crystal layer, the transmission axis of the front polarizer is perpendicular to the direction of the metal wire grid in the metal wire grid polarizing film.

Wherein the backlight module further including a diffusion sheet provided adjacent to the light emitting surface of the light guide plate.

The backlight module and the liquid crystal display device of the present application utilizes a metal wire grid polarizing film instead of the rear polarizer, and an additional layer of quarter-wave plate is deposited on the reflective sheet. The light emitted from the light source and passed into the metal wire grid polarizing film, the light component perpendicular to the metal wire grid is effectively utilized, the light components parallel to the metal wire grid is reflected into the quarter-wave plate, the reflected light is converted into circularly polarized light by the quarter wave plate, after reflected by the reflective sheet, the direction of the circularly polarized light is reversed, the reversed circularly polarized light is further pass the quarter wave plate and into a polarized light perpendicular to the metal wire grid, thereby causing the reflected light from the metal wire grid polarizing can be used effectively to improve the light utilization.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 illustrates a schematic structure of a liquid crystal display device according to an embodiment of the present application; and

FIG. 2 illustrates a schematic structure of a metal wire grid polarizing film according to an embodiment of the present application.

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained should be considered within the scope of protection of the present application.

Specifically, the terminologies in the embodiments of the present application are merely for describing the purpose of the certain embodiment, but not to limit the invention. Examples and the claims be implemented in the present application requires the use of the singular form of the book “an”, “the” and “the” are intend to include most forms unless the context clearly dictates otherwise. It should also be understood that the terminology used herein that “and/or” means and includes any or all possible combinations of one or more of the associated listed items.

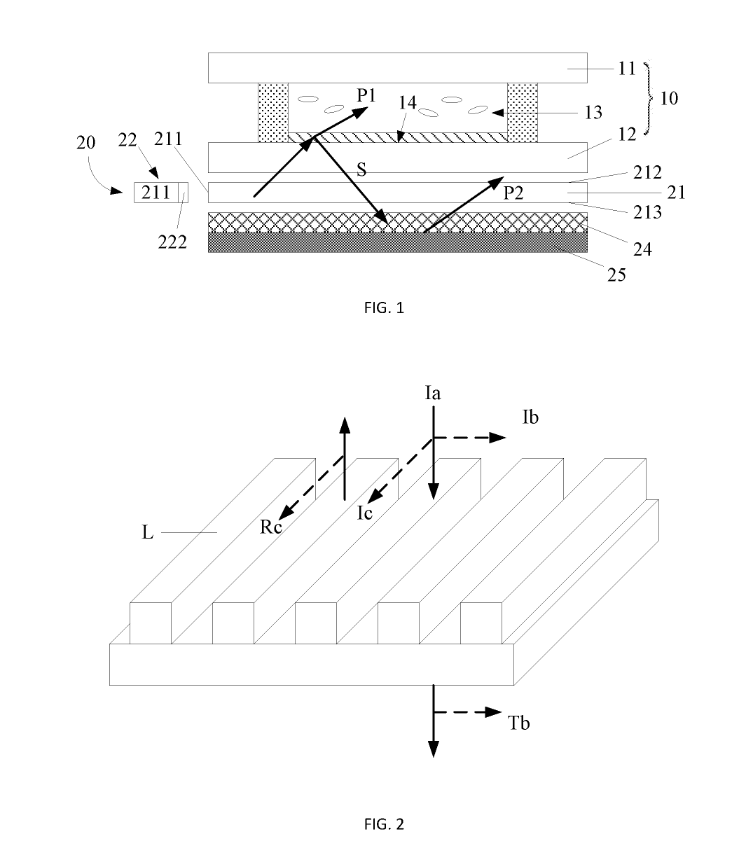

FIG. 1 illustrates a schematic structure of a liquid crystal display device according to an embodiment of the present application. Refer to FIG. 1, the liquid crystal display device of the embodiment includes a liquid crystal panel 10 and a backlight module 20 to provide light to the liquid crystal panel 10. The backlight module 20 includes a light guide plate 21, a light source 22, a metal wire grid polarizing film 23, a quarter-wave plate 24 and the reflective sheet 25.

The light guide plate 21 includes a light incident surface 211, a light emitting surface 212 and a reflective surface 213, wherein the light emitting surface 212 and the reflective surface 213 are respectively connected to the light incident surface 211 and opposite to each other. Wherein, the light emitting surface 212 is the upper surface of the light guide plate 21, the reflective surface 213 is the lower surface of the light guide plate 21, the light incident surface 211 is the side surface to connect to the upper surface and the lower surface. It should be understood that the light guide plate 21 may also include two light incident surface 211, i.e., the other light incident surface 211 is the other side surface opposite to the light incident surface 211 shown in FIG. 1

A light source 22 is provided adjacent to the light incident surface 211, preferably, the light source 22 in the embodiment includes a blue LED 221 and at least one quantum dot film 222, the at least one quantum dot film 222 is dispersed with red quantum dots and green quantum dots. The red quantum dots and the green quantum dots can be dispersed in one quantum dot film 222, or it can also be distributed in two quantum dot film 222, that is the red quantum dots is dispersed in the first quantum dot film and the green quantum dots is dispersed in a second quantum film.

Take the quantum dot film 222 shown in FIG. 1 as an example, the blue light emitted by the blue LED 221 passes through the quantum dot film 222 and the light guide plate 21, after partial of the blue light is absorbed from the red quantum dots and the green quantum dots dispersed in the quantum dot film 222. The red light is emitted from the red quantum dots, the green light is emitted from the green quantum dots, and the last partial of the blue light and the red light emitting from the red quantum dots and the green light emitting from the green quantum dots are mixed to form white light. Wherein the red quantum dots dispersed in the quantum dot film 222 have discrete electron level completely, green quantum dots also have discrete electron level completely, when the red and the green quantum dots irradiated by light, its valence and conduction bands on electronic transitions back and forth so as to emit light.

Based on this, in the structural design of the light source 22 of the present embodiment, the blue LED 221 and the quantum dot film 222 is two separate parts, and red light emitted from the red quantum dots is very pure monochromatic red light, the green light emitted from the green quantum dots is very pure monochromatic red light to achieve a high color gamut, and the red and green light emitted from the quantum dot film 222 will not be affected by the heat from the blue LED 221 generated in the working process and the discoloration problem can be avoided.

In the present embodiment, as the quantum dot film 222 is disposed on the optical path of the blue LED 221, the white light can be formed, in particular, quantum dots film 222, including the first quantum dot film and the second quantum dot film can be provided between the blue LED 221 and the light incident surface 211 of the light guide plate 21, or provided on the light emitting surface 212 or the reflective surface 213 of the light guide plate 11.

The liquid crystal panel 10 includes a first substrate 11 and a second substrate 12 with a relative space, wherein one of the first substrate 11 or the second substrate 12 is a color filter substrate, referred to as a CF substrate. The other of the first substrate 11 or the second substrate 12 is an array substrate, such as a thin film transistor substrate, referred to as a TFT substrate, and a liquid crystal layer 13 filled between the two substrates, the liquid crystal layer 13 is located in the liquid crystal cell between the array substrate and the color filter substrate.

Based on the above, the liquid crystal panel 10 also includes a built-in metal wire grid polarizing film 14, such is the metal wire grid polarizing film 14 is disposed between the array substrate and color filter substrate of the liquid crystal panel 10. The metal wire grid polarizing film 14 is disposed between the light emitting surface 212 of the light guide plate 21 and the liquid crystal layer 13, specifically is disposed adjacent to the liquid crystal layer 13 side toward the light guide plate 21. As shown in FIG. 1, such as the metal wire grid polarizing film 14 disposed on the upper surface of the second substrate 12. Wherein the wire grid of the metal wire grid polarizing film 14 can be formed directly on the glass substrate of the second substrate 12 of the liquid crystal panel 10, i.e., the metal wire grid polarizing film 14 and the second substrate 12 share a glass substrate.

Referring to FIG. 2 illustrates a schematic structure of a metal wire grid polarizing film according to an embodiment of the present application. The light perpendicular to the direction L of the metal wire grid can pass through the metal wire grid polarizing film 14, the light parallel to the direction L of the metal wire grid is reflected. For example, the Ia is an incident light, Ib and Ic are a perpendicular component and a parallel component of Ia, so Ib will pass through the metal wire grid and is called polarized light Tb, and the incident light Ic is reflected to be called as a reflected light Rc.

A quarter-wave plate 24 is adjacent to the reflective surface 213 of the light guide plate 21. The quarter-wave plate 24 is a birefringent single crystal paddles having a certain thickness, with a slow axis and a fast-axis, the direction of the slow axis is perpendicular to the optical axis direction, the direction of the fast axis is parallel to the optical axis direction where the optical axis direction is the light transmission direction and not produce birefringence.

Wherein the angle between the fast axis of the quarter wave plate 24 and the direction of the metal wire grid of the metal wire grid polarizing film 14 is 45°.

A reflective sheet 25 is disposed on the side of the quarter-wave plate 24 facing away from the light guide plate 21, to reflect the light emitted from the reflective surface 213 to the light guide plate 21, thereby reducing the loss of light.

Conjunction with FIG. 1, the white light from the light source 22 is incident to the light guide plate 21 from the incident surface 211 at a predetermined angle, wherein the predetermined angle is greater than zero and less than 90°, the light source 22 is converted to a surface light source by the light guide plate 21. After the light into the metal wire grid polarizing film 14, the light component P1 perpendicular to the metal wire grid is effectively used, the light component S parallel to the metal wire grid is reflected and into the quarter wave plate 24, the quarter-wave plate 24 convert the reflected light (light component S) into a circularly polarized light, and after reflected by the reflective sheet 25, the direction of circularly polarized light is reversed, for example, left-handed circularly polarized light becomes right-handed circularly polarized light and left-handed or right-handed circularly polarized light becomes circularly polarized light, the reversed circularly polarized light P2 is further pass the quarter wave plate 24 again and is converted into polarized light perpendicular to the metal wire grid, such that the light reflected by the metal wire grid polarizing film 14 is also possible to effectively use and improve the utilization of light.

The embodiment of the liquid crystal display device of the present invention can further includes a diffusion sheet, the diffusion sheet is disposed between the light guide plate 21 and the metal wire grid polarizing film 14. Specifically, the diffusion sheet can be attached to the outer surface of the second substrate 12 of the liquid crystal panel 10 to further scattering the light emitted from the light guide plate 21, so that the light can emitting toward the liquid crystal panel 10 more uniformly.

In the structural design of the embodiment of the present invention, in view of the use of a metal wire grid polarizing film 14 to replace the rear polarizing plate in the conventional technology, the liquid crystal panel 10 further includes a front polarizer 15 disposed on the side of the first substrate 11 opposite to the liquid crystal layer 13, such as the front polarizer 15 is disposed on the display side of the liquid crystal display panel 10, the transmission axis of the front polarizer 15 is perpendicular to the direction of the metal wire grid in the metal wire grid polarizing film 14. It should be understood that the embodiments of the liquid crystal display device of the present invention can further include other optical films structure, it is not limited to as shown in FIG. 1.

After the above, instead of the rear polarizer the present embodiment of the invention utilizing a metal wire grid polarizing film, and an additional layer of quarter-wave plate is deposited on the reflective sheet. The light emitted from the light source and passed into the metal wire grid polarizing film, the light component perpendicular to the metal wire grid is effectively utilized, the light components parallel to the metal wire grid is reflected into the quarter-wave plate, the reflected light is converted into circularly polarized light by the quarter wave plate, after reflected by the reflective sheet, the direction of the circularly polarized light is reversed, the reversed circularly polarized light is further pass the quarter wave plate and into a polarized light perpendicular to the metal wire grid, thereby causing the reflected light from the metal wire grid polarizing can be used effectively to improve the light utilization.

Above are embodiments of the present application, which does not limit the scope of the present application. Any modifications, equivalent replacements or improvements within the spirit and principles of the embodiment described above should be covered by the protected scope of the invention.

What is claimed is:

1. A backlight module, comprising
a light guide plate having a light incident surface, a light emitting surface and a reflective surface respectively connected to the light incident surface and opposite to each other;
a light source provided adjacent to the light incident surface, and the light source having a blue LED, red quantum dots and green quantum dots, the light emitted from the blue LED is mixed with the red quantum dots and green quantum dots to form white light;
a diffusion sheet provided adjacent to the light emitting surface of the light guide plate;
a metal wire grid polarizing film disposed on a side of the light emitting surface of the light guide plate, and the diffusion sheet is disposed between the light guide plate and the metal wire grid polarizing film;
a quarter-wave plate disposed adjacent to the reflective surface of the light guide plate, wherein the angle between the fast axis of the quarter wave plate and the direction of the metal wire grid of the metal wire grid polarizing film is 45°; and
a reflective sheet disposed on the side of the quarter-wave plate facing away from the light guide plate.

2. The backlight module according to claim 1, wherein the red quantum dots and the green quantum dots are dispersed in a first quantum dot film and a second quantum film, wherein the first quantum dot film and a second quantum film are disposed between the blue LED and the light incident surface of the light guide plate, or disposed one the light emitting surface of the light guide plate.

3. The backlight module according to claim 1, wherein the red quantum dots and the green quantum dots are dispersed in one quantum dot film, wherein the quantum dot film is disposed between the blue LED and the light incident surface of the light guide plate, or disposed one the light emitting surface of the light guide plate.

4. A backlight module, comprising
a light guide plate having a light incident surface, a light emitting surface and a reflective surface respectively connected to the light incident surface and opposite to each other;
a light source provided adjacent to the light incident surface;
a metal wire grid polarizing film disposed on a side of the light emitting surface of the light guide plate;
a quarter-wave plate disposed adjacent to the reflective surface of the light guide plate, wherein the angle between the fast axis of the quarter wave plate and the direction of the metal wire grid of the metal wire grid polarizing film is 45°; and
a reflective sheet disposed on the side of the quarter-wave plate facing away from the light guide plate.

5. The backlight module according to claim 1, wherein the light source further comprising a blue LED, red quantum dots and green quantum dots, the light emitted from the blue LED is mixed with the red quantum dots and green quantum dots to form white light.

6. The backlight module according to claim 5, wherein the red quantum dots and the green quantum dots are dispersed in a first quantum dot film and a second quantum film, wherein the first quantum dot film and a second quantum film are disposed between the blue LED and the light incident surface of the light guide plate, or disposed one the light emitting surface of the light guide plate.

7. The backlight module according to claim 5, wherein the red quantum dots and the green quantum dots are dispersed in one quantum dot film, wherein the quantum dot film is disposed between the blue LED and the light incident surface of the light guide plate, or disposed one the light emitting surface of the light guide plate.

8. The backlight module according to claim 4, further comprising a diffusion sheet provided adjacent to the light emitting surface of the light guide plate.

9. A liquid crystal display device, comprising a liquid crystal panel and a backlight module to provide light to the liquid crystal panel, wherein the backlight module further comprising:
a light guide plate having a light incident surface, a light emitting surface and a reflective surface respectively connected to the light incident surface and opposite to each other;
a light source provided adjacent to the light incident surface;
a metal wire grid polarizing film disposed on a side of the light emitting surface of the light guide plate;
a quarter-wave plate disposed adjacent to the reflective surface of the light guide plate, wherein the angle between the fast axis of the quarter wave plate and the direction of the metal wire grid of the metal wire grid polarizing film is 45°; and
a reflective sheet disposed on the side of the quarter-wave plate facing away from the light guide plate.

10. The liquid crystal display device according to claim 9, wherein the liquid crystal panel comprising a first substrate and a second substrate; and a liquid crystal layer filled between the first substrate and the second substrate; wherein the metal wire grid polarizing film is disposed between the first substrate and the second substrate and is disposed adjacent to the liquid crystal layer toward to the side of the light guide plate.

11. The liquid crystal display device according to claim 9, wherein the liquid crystal panel comprising a first substrate and a second substrate; and a liquid crystal layer filled between the first substrate and the second substrate; wherein the second substrate is disposed adjacent the light emitting surface of the light guide plate, and the metal wire grid polarizing film is disposed between the first substrate and the light emitting surface of the light guide plate.

12. The liquid crystal display device according to claim 9, wherein the liquid crystal panel further comprising a front polarizer disposed on the side of the first substrate opposite to the liquid crystal layer, the transmission axis of the front polarizer is perpendicular to the direction of the metal wire grid in the metal wire grid polarizing film.

13. The liquid crystal display device according to claim 9, wherein the backlight module further comprising a diffusion sheet provided between the light guide plate and the metal wire grid polarizing film.
